(19) United States
(12) Patent Application Publication
(10) Pub. No.: US 2001/0006441 A1
(43) Pub. Date: Jul. 5, 2001

(54) Floppy disk drive in which an eject lever is attached to a projection formed integral with a main frame thereof

(76) Inventors: Hisateru Komatsu, Tendo-shi (JP); Mamoru Takahashi, Murayama-shi (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(21) Appl. No.: 09/748,937

(22) Filed: Dec. 27, 2000

(30) Foreign Application Priority Data
Dec. 27, 1999 (JP) 371296/1999

(51) Int. Cl. G11B 17/02

(52) U.S. Cl. 360/99.02

(57) ABSTRACT

In a floppy disk drive for driving a floppy disk loaded therein, a main frame has a principal surface defining a disk-loading area in which the floppy disk is loaded. A shaft portion is protruded from the principal surface of the main frame. The shaft portion is formed integral with the main frame from a single member. An eject lever is attached to the shaft portion to be rotatable around the shaft portion. The eject lever is for ejecting the floppy disk from the disk-loading area.

### BACKGROUND OF THE INVENTION

This invention relates to a floppy disk drive for driving a floppy disk or a flexible disk to carry out data recording/reproducing operations for a disk-shaped magnetic recording medium contained in the floppy disk.

The floppy disk drive of the type is mounted in a portable electronic equipment such as a laptop personal computer, a notebook personal computer, or a notebook word processor. In order to carry out recording/reproducing operations of data, the floppy disk drive is loaded or inserted with a floppy disk known in the art.

In the manner known in the art, a conventional floppy disk drive comprises a magnetic head for reading/writing data from/to the magnetic recording medium contained in the floppy disk, a carriage assembly for moving the magnetic head with respect to the floppy disk in a predetermined radial direction, a stepping motor for moving the carriage assembly in the predetermined radial direction, and a direct drive motor such as a spindle motor for driving and rotating the magnetic recording medium while the floppy disk is held.

The conventional floppy disk drive further comprises an eject mechanism for ejecting the floppy disk from the floppy disk drive and a main frame for guiding operation of the eject mechanism. Such an eject mechanism is disclosed, for example, in Japanese Unexamined Patent Publications (JP-A) Nos. H09-91944 and H09-312070.

The eject mechanism includes an eject lever arranged in the vicinity of the carriage assembly on the main frame. The eject lever is attached rotatable around a rod pin which is formed separately from the main frame and fixed to the main frame by caulking or by the use of a screw to stand up on the main frame.

In the conventional disk drive, inasmuch as the rod pin as an independent component is fixed to the main frame by caulking or by the use of the screw to stand up on the main frame, the number of components and the number of steps required in assembling the eject lever to the main frame are inevitably increased.

### SUMMARY OF THE INVENTION

It is therefore an object of this invention to provide a floppy disk drive which can be reduced in number of components and in number of steps required in assembling an eject lever to a main frame.

Other objects of the present invention will become clear as the description proceeds.

According to this invention, there is provided a floppy disk drive for driving a floppy disk loaded therein. The floppy disk drive comprises a main frame having a principal surface defining a disk-loading area in which the floppy disk is loaded, a shaft portion protruded from the principal surface of the main frame, the shaft portion being formed integral with the main frame from a single member, and an eject lever attached to the shaft portion and rotatable around the shaft portion for ejecting the floppy disk from the disk-loading area.

### BRIEF DESCRIPTION OF THE DRAWING

FIG. 1 is a perspective view of a conventional floppy disk drive;

FIG. 2 is a perspective view of an eject lever and a rod pin formed on a main frame illustrated in FIG. 1;

FIG. 3 is a plan view of a typical floppy disk;

FIG. 4 is an exploded perspective view of a floppy disk drive according to this invention;

FIG. 5 is a perspective view of the floppy disk drive illustrated in FIG. 4 in an assembled state;

FIG. 6 is a top plan view of a combination of an eject lever and a main frame illustrated in FIG. 5;

FIG. 7 is a plan view of the main frame illustrated in FIG. 6;

FIG. 8 is a bottom plan view of the combination of the eject lever and the main frame illustrated in FIG. 6;

FIG. 9 is a sectional view of a protruding shaft portion, taken along a line X-X in FIG. 7;

FIG. 10 is a sectional view of a modification of the protruding shaft portion illustrated in FIG. 9;

FIG. 11 is a top plan view of the eject lever illustrated in FIG. 6;

FIG. 12 is a right side view of the eject lever illustrated in FIG. 6;

FIG. 13 is a sectional view of a combination of the eject lever, the main frame, and a disk holder illustrated in FIG. 6; and

FIG. 14 is a bottom plan view of the eject lever illustrated in FIG. 11.

### DESCRIPTION OF THE PREFERRED EMBODIMENT

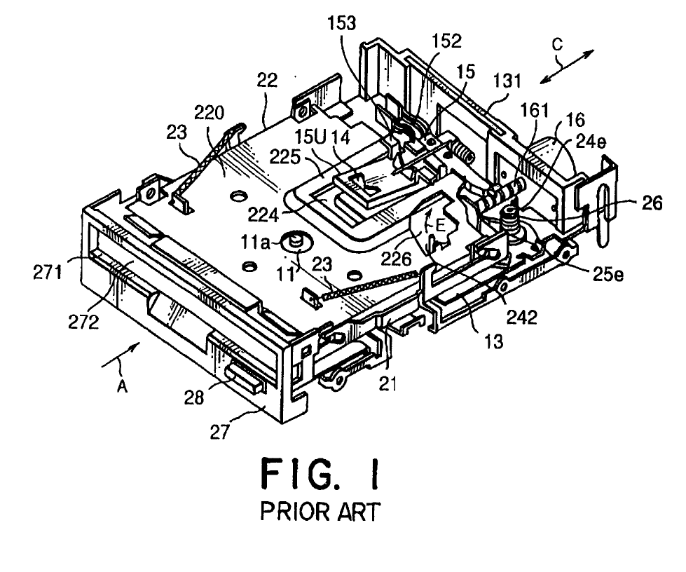

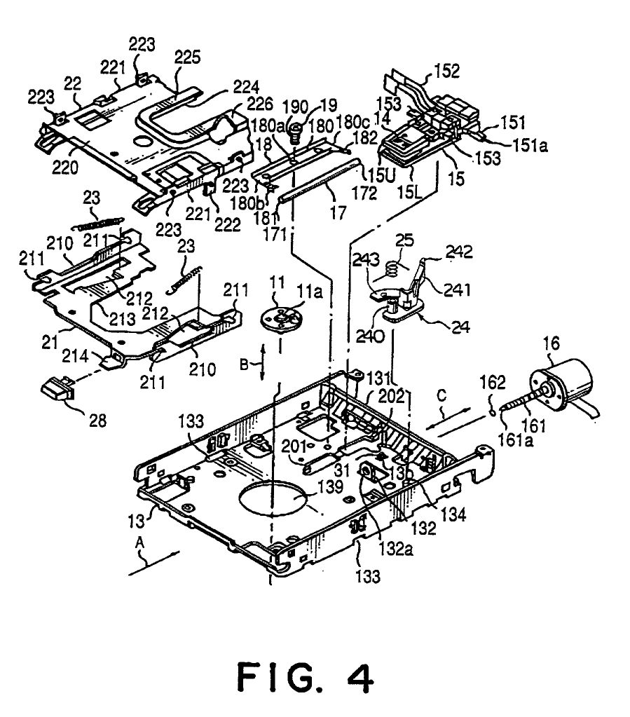

In order to facilitate an understanding of this invention, description will at first be made of a conventional floppy disk drive with reference to FIGS. 1 through 3. The floppy disk drive illustrated in FIG. 1 is adapted to be loaded in a portable electronic equipment to drive a 3.5-inch floppy disk 40 (FIG. 3).

Referring to FIG. 1, the floppy disk 40 is inserted into or loaded in the floppy disk drive in an inserting direction depicted by an arrow A. The floppy disk 40 inserted into the floppy disk drive is held on a disk table 11 having a rotation shaft 11a in the state where the rotation shaft 11a of the disk table 11 is coincident with a center axis of the floppy disk 40.

The disk table 11 is driven and rotated by a spindle motor or a direct drive motor, not shown in the figure, mounted on a lower surface of a main frame 13. The spindle motor serves to rotate a magnetic recording medium contained in the floppy disk 40.

The floppy disk drive comprises a pair of upper and lower magnetic heads 14 (only the upper magnetic head being illustrated in the figure) for reading/writing data from/to the magnetic recording medium in the floppy disk 40. The magnetic heads 14 are supported by an end of a carriage assembly 15 arranged on a rear side of the floppy disk drive. Specifically, the carriage assembly 15 comprises an upper carriage 15U supporting the upper magnetic head 14 and a lower carriage 15L supporting the lower magnetic head 14. The carriage assembly 15 is disposed on an upper surface of the main frame 13 with a space kept from the main frame 13. The carriage assembly 15 supports the magnetic heads 14 at its tip so that the magnetic heads 14 are movable with respect to the floppy disk 40 in a predetermined radial direction depicted by an arrow C in FIG. 1.

The main frame 13 has a rear side wall 131 provided with a stepping motor 16 fixed thereto. The stepping motor 16 serves to linearly drive the carriage assembly 15 in the predetermined radial direction C. Specifically, the stepping motor 16 has a rotation shaft (drive shaft) 161 extending in parallel to the predetermined radial direction C. The rotation shaft 161 is defined in position to extend in parallel to the predetermined radial direction C. The rotation shaft 161 has a tip 161 a rotatably supported.

A plurality of flexible printed circuits (FPC) 152 extend from the carriage assembly 15. The FPCs 152 are electrically connected to a substrate (not shown) attached to the lower surface of the main frame 13.

The floppy disk drive further comprises an eject plate 21 and a disk holder 22. The eject plate is mounted on the main frame 13 to be slidable in the inserting direction A of the floppy disk 40 and an ejecting direction opposite thereto. The eject plate 21 holds the floppy disk 40 in cooperation with the disk holder 22 when the floppy disk drive is operated. The eject plate 21 allows the floppy disk 40 to be inserted into the floppy disk drive in the inserting direction A and to be ejected from the floppy disk drive in the ejecting direction.

The disk holder 22 is disposed on the eject plate 21. Between the disk holder 22 and the eject plate 21, a pair of eject springs 23 are bridged.

The disk holder 22 has a generally rectangular opening 224 formed at its center portion inward in the inserting direction A. The opening 224 is located at a position corresponding to the upper carriage 15U of the carriage assembly 15 and extends in the predetermined radial direction C. The opening 224 is surrounded by a generally U-shaped protruding edge 225 protruding upward from a principal surface 220 of the disk holder 22 along the periphery of the opening 224.

On the other hand, the carriage assembly 15 has a pair of lateral arms 153 extending in a lateral direction. The lateral arms 153 are located on or above the protruding edge 225. In the state where the floppy disk 40 is ejected from the disk holder 22, the lateral arms 153 are engaged with the protruding edge 225 to separate the upper and the lower magnetic heads 14 from each other.

In addition, the disk holder 22 has an opening 226 formed inward in the inserting direction A at a right-hand side of the opening 224. The opening 226 has such a shape as to allow the rotation of a lever part of an eject lever which will later be described.

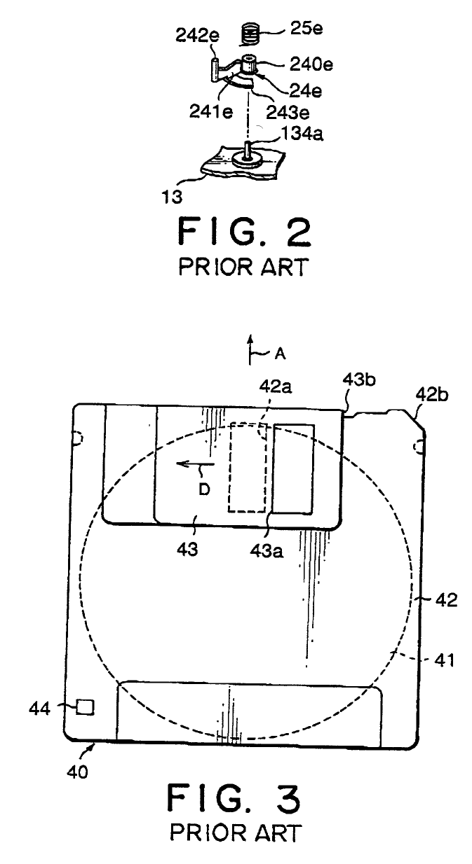

On the main frame 13, the eject lever depicted at 24e (also shown in FIG. 2) is rotatably arranged in the vicinity of the carriage assembly 15.

Referring to FIG. 2 in addition, description will be made in further detail. The main frame 13 is provided with a rod pin 134a standing up and extending upward from a principal surface or the upper surface thereof. The upper surface of the main frame 13 defines a disk-loading area in which the floppy disk 40 is loaded or set. The eject lever 24e comprises a cylindrical part 240e receiving the rod pin 134a fitted therein, an arm part (lever part) 241e extending from the cylindrical part 240e in a radial direction, a projecting part 242e formed at a free end of the arm part 241e to extend upward, and an arc-shaped locking part 243e extending from a free-end side of the arm part 241e in a circumferential direction.

In the eject lever 24e, an eject lever spring 25e is fitted around the cylindrical part 240e to urge the eject lever 24e in a counterclockwise direction in the figure. The arm part 241e presses the floppy disk 40 when the floppy disk 40 is ejected. The projecting part 242e of the eject lever 24e is loosely fitted in the opening 226 of the disk holder 22. The projecting part 242e is engaged with an upper end 43b of a right-hand edge of a shutter 43 in the floppy disk 40 to controllably open and close the shutter 43.

To a tip of the rod pin 134a, a screw 26 is inserted to prevent the eject lever 24e from being released from the rod pin 134a. The rod pin 134a is fixed to the main frame 13 by caulking or by the use of a screw to stand up on the main frame 13.

The main frame 13 is provided with a front panel 27 attached to its front end portion. The front panel 27 has an opening 271 for insertion and ejection of the floppy disk 40 and a door 272 for closing the opening 271. The front panel 27 is provided with an eject button 28 protruding therefrom to be movable backward and forward.

Referring to FIG. 3, description will be made of the floppy disk 40 driven by the floppy disk drive illustrated in FIG. 1. The floppy disk 40 comprises a disk-shaped magnetic recording medium 41, a shell 42 covering the magnetic recording medium 41, and a shutter 43 slidably movable in a direction depicted by an arrow D.

The shutter 43 of the floppy disk 40 is provided with a window 43a. The shutter 43 is urged by a spring member (not shown) in a direction opposite to the direction D. The shell 42 is provided with an opening 42a allowing an access to the magnetic recording medium 41 by the magnetic heads 14. When the floppy disk 40 is not inserted into the floppy disk drive, the opening 42a is covered with the shutter 43. When the floppy disk 40 is inserted into the floppy disk drive, the projecting part 242e of the eject lever 24e is engaged with the upper end 43b of the right-hand edge of the shutter 43 to slide the shutter 43 in the direction D.

The shell, 42 is provided with a chamfered portion 42b formed at an upper right corner thereof to prevent the floppy disk 40 from being erroneously inserted in a reversed position in the vertical direction and in the inserting direction, i.e., upside down and front side back. The shell 42 is provided with a write-protection hole 44 formed at a rear left corner in the inserting direction A.

In the above-mentioned floppy disk 40 driven by the floppy disk drive, the magnetic recording medium 41 accessed by the magnetic heads 14 is provided with a plurality of tracks (not shown) concentrically formed on each of opposite surfaces thereof in parallel to one another in a radial direction. The tracks serve as paths for recording data. For example, the tracks on one surface of the floppy disk 40 is equal to 80 in number, from the outermost track TR00 to the innermost track 79.

The floppy disk 40 loaded in the floppy disk drive is placed on the disk table 11. A drive roller (not shown) of the floppy disk drive is fitted into a hole formed in a hub (not shown) of the floppy disk 40 to drive and rotate the magnetic disk medium 41 contained in the floppy disk 40.

The elect lever 24e made of a nonmagnetic material such as resin serves both as a shutter driving mechanism for opening and closing the shutter 43 and as an eject mechanism for ejecting the floppy disk 40 from the floppy disk drive.

By pushing the eject button 28 protruding outward from the front panel 27, the eject plate 21 is slightly moved rearward to rotate the eject lever 24e.

The floppy disk 40 loaded in the floppy disk drive is prevented from being undesirably ejected from the floppy disk drive because it is locked by a lock mechanism (not shown). When the lock mechanism is unlocked, the floppy disk 40 is ejected by the eject lever spring 25 as a spring mechanism urging the eject lever 24e so that a part of the floppy disk 40 is ejected outward through the opening 271 of the front panel 27.

The eject plate 21 is provided with the eject spring 23 as a spring mechanism. When the pressing of the eject button 28 is cancelled, the eject plate 21 is returned to its initial position by the eject spring 23. In the above-mentioned manner, the floppy disk 40 can be removed from the floppy disk drive.

As described above, in the conventional disk drive, the rod pin 134 as a separate component is fixed to the main frame 13 by caulking or by the use of the screw to stand up on the main frame 13. Thus, the number of components and the number of steps required in assembling the eject lever 24e to the main frame 13 are inevitably increased.

Now, description will be made of an embodiment of this invention with reference to the drawing. Similar parts are designated by like reference numerals.

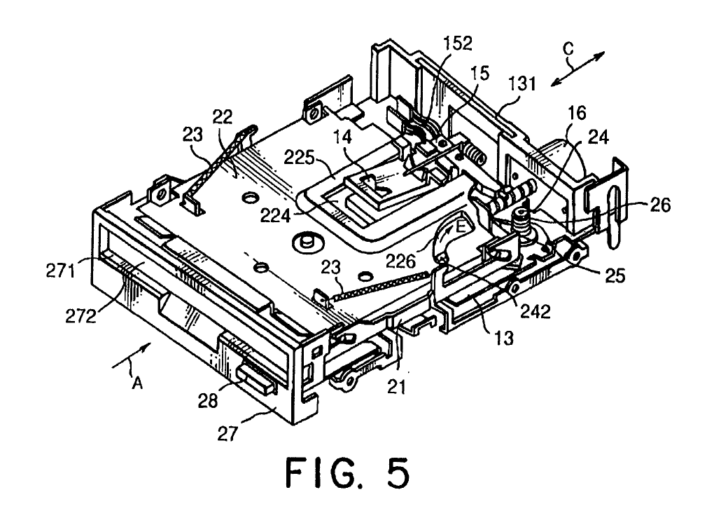

Referring to FIGS. 4 and 5, a floppy disk drive being illustrated is adapted to be mounted in a portable electronic equipment to drive a 3.5-inch floppy disk 40 (see FIG. 3). The floppy disk 40 is inserted into the floppy disk drive in an inserting direction depicted by an arrow A in FIGS. 4 and 5. The floppy disk 40 thus inserted is held on a disk table 11 having a rotation shaft 11a in the state where the rotation shaft 11a of the disk table 11 is coincident with a center axis of the floppy disk 40.

The rotation shaft 11a of the disk table 11 is inserted through a spring (not shown) into a bearing (not shown) received in a hole 139 formed in a main frame 13. In this manner, the disk table 11 is rotatably supported on a first or upper surface of the main frame 13.

The rotation shaft 11a of the disk table 11 has an axial direction B parallel to a thickness direction of the main frame 13. The disk table 11 is driven and rotated by a spindle motor mounted on a second or lower surface of the main frame 13 so that a magnetic recording medium 41 contained in the floppy disk 40 is rotated. On the lower surface of the main frame 13, a substrate or board (not shown) with a number of electronic parts mounted thereon is attached.

The floppy disk drive comprises a pair of upper and lower magnetic heads 14 (only the upper one being illustrated in the figure) for reading/writing data from/to the magnetic recording medium 41 in the floppy disk 40 illustrated in FIG. 3.

The magnetic heads 14 are supported by a tip of a carriage assembly 15 arranged on a rear side of the floppy disk drive. Specifically, the carriage assembly 15 comprises an upper carriage 15U supporting the upper magnetic head 14 and a lower carriage 15L supporting the lower magnetic head 14.

The carriage assembly 15 is disposed on the upper surface of the main frame 13 with a space kept from the main frame 13. The carriage assembly 15 supports the magnetic heads 14 at its tip so that the magnetic heads 14 are movable with respect to the floppy disk 40 in a predetermined radial direction depicted by an arrow C in FIGS. 4 and 5.

The main frame 13 has a rear side wall 131 provided with a stepping motor 16 fixed thereto. The stepping motor 16 serves to linearly drive the carriage assembly 15 in the predetermined radial direction C. Specifically, the stepping motor 16 has a rotation shaft (drive shaft) 161 extending in parallel to the predetermined radial direction C.

The rotation shaft 161 is threaded to form a male screw. The rotation shaft 161 has a tip 161a. On the other hand, the main frame 13 has a bent portion 132 formed by a cut-and-bend process to stand up on its upper surface. The bent portion 132 is provided with a hole 132a. The tip 161a of the rotation shaft 161 penetrates the hole 132a of the bent portion 132. The tip 161a of the rotation shaft 161 is provided with a steel ball 162. By the hole 132a and the steel ball 162, the rotation shaft 161 is defined in position to extend in parallel to the predetermined radial direction C and the Up 161a of the rotation shaft 161 is rotatably held.

On the other hand, the carriage assembly 15 comprises an arm 151 extending from the lower carriage 15L to the rotation shaft 161. The arm 151 has an arm end 151a engaged with a root of the male screw of the rotation shaft 161. Therefore, when the rotation shaft 161 of the stepping motor 16 is rotated, the arm end 151a of the arm 151 is moved along the root of the male screw of the rotation shaft 161 so that the carriage assembly 15 itself is moved in the predetermined radial direction C. Thus, the stepping motor 16 serves as driving means for linearly moving the carriage assembly 15 in the predetermined radial direction C.

The rotation shaft 161 of the stepping motor 16 is disposed on one side of the carriage assembly 15. Therefore, the one side of the carriage assembly 15 is movably supported by the rotation shaft 161 with a space kept from the frame 13. However, only by the rotation shaft 161 supporting the one side, the whole of the carriage assembly 15 can not be kept spaced from the upper surface of the main frame 13. Therefore, the other side of the carriage assembly 15 is supported by a guide bar 17 to guide the movement of the carriage assembly 15.

Thus, the rotation shaft 161 of the stepping motor 16 and the guide bar 17 are arranged on me one side and on the other side of the carriage assembly 15. The guide bar 17 extends in parallel to the predetermined radial direction C and has one end 171 and the other end 172 fixed on the upper surface of the main frame 13. The guide bar 17 serves to guide the carriage assembly 15 in the predetermined radial direction C. With this structure, the whole of the carriage assembly 15 is kept spaced from the upper surface of the main frame 13.

In addition, a plurality of flexible printed circuits (FPC) 152 extend from the carriage assembly 15 on the side of the guide bar 17. The FPCs 152 are electrically connected to the substrate (not shown) attached to the lower surface of the main frame 13.

The guide bar 17 is clamped on the upper surface of the main frame 13 by a guide bar clamp 18. The guide bar clamp 18 is fixed at its center to the upper surface of the main frame 13 by the use of a binding screw 19.

Specifically, the guide bar clamp 18 comprises a rectangular fixing member 180 slightly longer in length than the guide bar 17. The rectangular fixing member 180 is provided with a hole 180a formed approximately at its center to allow the insertion of a screw shaft 190 of the binding screw 19. The rectangular fixing member 180 has one end 180b and the other end 180c provided with a pair of arms 181 and 182 extending therefrom to clamp the one end 171 and the other end 172 of the guide bar 17, respectively.

Since the guide bar clamp 18 merely clamps the guide bar 17, the guide bar 17 can not be fixed to the upper surface of the main frame 13 by the guide bar clamp 18 alone. Therefore, a pair of positioning members for defining positions of the one end 171 and the other end 172 of the guide bar 17 are required. The positioning members are implemented by a pair of bent portions 201 and 202 each of which is formed by cutting and bending a part of the main frame 13 to stand up from the upper surface of the main frame 13.

The lower carriage 15L of the carriage assembly 15 also serves as a supporting frame supporting the carriage assembly 15 so that the carriage assembly 15 is slidable along the guide bar 17. The lower carriage 15L has a projecting portion (not shown) projecting towards the guide bar 17. The guide bar 17 is slidably fitted in the projecting portion.

The floppy disk drive further comprises an eject plate 21 and a disk holder 22. Each of the main frame 13, the eject plate 21, and the disk holder 22 is formed by punching, pressing, and bending a metal plate.

The eject plate 21 is mounted on the main frame 13 to be slidable in the inserting direction A of the floppy disk 40 and an ejecting direction opposite thereto. In the manner which will later be described, the eject plate 21 holds the floppy disk 40 in cooperation with the disk holder 22 when the floppy disk drive is operated.

In order to allow the floppy disk 40 to be inserted into the floppy disk drive in the inserting direction A and to be ejected from the floppy disk drive in the ejecting direction, the eject plate 21 holds the floppy disk 40 so that the floppy disk 40 is slidable in the inserting direction A and the ejecting direction.

The eject plate 21 comprises a pair of side walls 210 faced to each other. Each of the side walls 210 has a pair of cam portions 211. In addition, the eject plate 21 has a bottom wall provided with a pair of cut portions 212 formed along the both side walls 210, respectively, and a generally U-shaped opening portion 213 formed at a center portion thereof to surround the disk table 11.

The disk holder 22 is disposed on the eject plate 21. The disk holder 22 has a principal surface 220 and a pair of side walls 221 formed at both lateral ends of the principal surface 220 to face each other. The both side walls 221 are provided with projections 222 (only one being illustrated), respectively. The projections 222 are inserted into a pair of holes 133 formed in the main frame 13 through the cut portions 212 of the eject plate 21, respectively. By inserting the projections 222 into the holes 133 of the main frame 13, the disk holder 22 is positioned with respect to the main frame 13 in the inserting direction A. Simultaneously, the disk holder 22 is allowed to perform reciprocating movement in the axial direction B of the rotation shaft 11a of the disk table 11.

Each of the both side walls 221 has a pair of pins 223. The pins 223 are inserted in the cam portions 211 formed in each of the side walls 210 of the eject plate 21, respectively. Between the disk holder 22 and the eject plate 21, a pair of eject springs 23 are bridged.

In the example being illustrated, the projections 222 are formed on the disk holder 22 while the holes 133 are formed in the main frame 13.

Alternatively, projections may be formed on the main frame while holes are formed in the disk holder 22.

The disk holder 22 has a generally rectangular opening 224 formed at its center portion inward in the inserting direction A. The opening 224 is located at a position corresponding to the upper carriage 15U of the carriage assembly 15 and extends in the predetermined radial direction C. The opening 224 is surrounded by a generally U-shaped protruding edge 225 protruding upward from the principal surface 220 of the disk holder 22 along the periphery of the opening 224.

On the other hand, the carriage assembly 15 has a pair of lateral arms 153 extending in a lateral direction. The lateral arms 153 are located on or above the protruding edge 225. In the state where the floppy disk 40 is ejected from the disk holder 22, the lateral arms 153 are engaged with the protruding edge 225 to separate the upper and the lower magnetic heads 14 from each other, as will later be described. In addition, the disk holder 22 has an opening 226 formed inward in the inserting direction A at a right-hand side of the opening 224. The opening 226 has such a shape as to allow the rotation of a lever part of an eject lever 24 which will later be described.

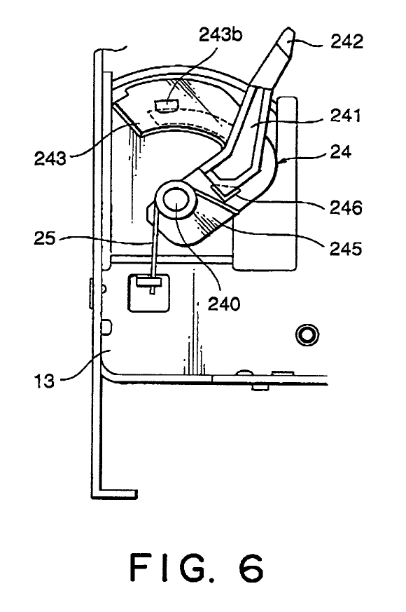

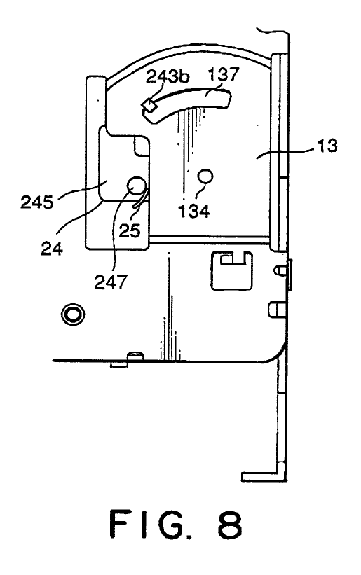

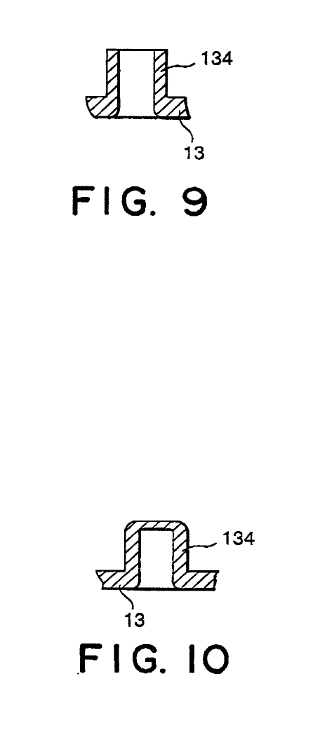

On the main frame 13, the eject lever 24 is rotatably arranged in the vicinity of the carriage assembly 15. Referring to FIGS. 6 through 9, description will be made in detail about a fixing structure of the eject lever 24. As illustrated in FIG. 9, the main frame 13 is provided with a protruding shaft portion 134 protruding upward from the upper surface thereof. The shaft portion 134 is formed integral with the main flame 13 from a single member in the manner which will far later be described in detail.

The protruding shaft portion 134 is formed by the use of a metal plate member which forms the main frame 13, i.e., formed by a part of the main frame 13 to be integral therewith. The protruding shaft portion 134 can be formed into a cylindrical shape by burring from the lower surface to the upper surface of the main frame 13. Alternatively, a protruding shaft portion 134′ having a cylindrical shape with a closed end may be formed by coining or drawing, as illustrated in FIG. 10.

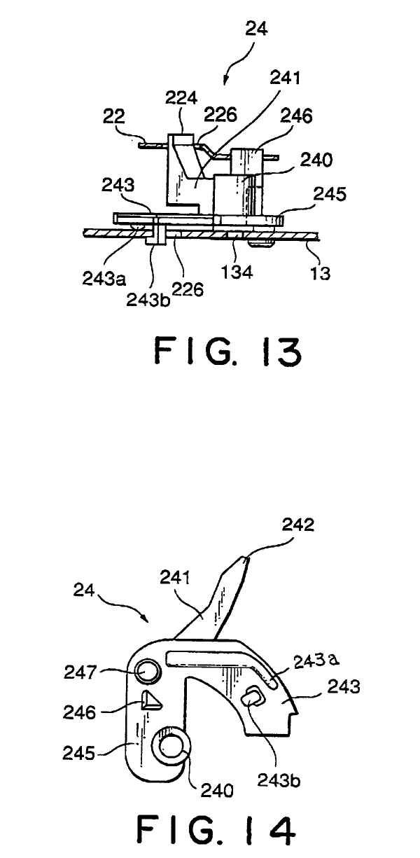

Referring to FIGS. 11 through 14, the eject lever 24 comprises a bar base part 245 of a generally rectangular shape, a cylindrical part 240 standing up on one or upper surface of the bar base part 245 to receive the protruding shaft portion 134 fitted therein, an arm part (lever part) 241 extending in a radial direction from the bar base part 245 on the side of the cylindrical part 240, a projecting part 242 formed at a free end of the arm part 241 to extend upward, an arc-shaped locking plate part 243 extending from one end of the bar base part 245 below the arm part 241 in a circumferential direction, a holder receiving part 246 located at a base of the arm part 241 and standing up on the upper surface of the bar base part 245, and a columnar part 247 extending downward from the other or lower surface of the bar base part 245.

More particularly, the bar base part 245 has a flat shape and extends from the cylindrical part 240 in parallel to the upper surface of the main frame 13. The arm part 241 is connected to the bar base part 245 and extends along the upper surface of the main frame 13. The arm part 241 is for pressing the floppy disk 40 to eject the floppy disk 40 from the disk-loading area.

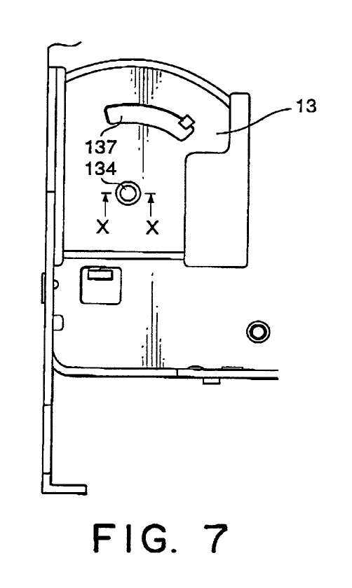

As illustrated in FIGS. 7, 8, and 13, the main frame 13 is provided with an arc-shaped opening 137 in the vicinity of the cylindrical part 240. The opening 137 is substantially concentric with the arc-shaped locking plate part 243. The opening 137 communicates the upper surface with a lower surface or an opposite surface opposite to the upper surface of the main frame 13. The locking plate part 243 extends from the bar base part 245 through a gap between the arm part 241 and the main frame 13. The locking plate part 243 has an engaging piece 243b passing through the opening 137. The engaging piece 243b has an end portion slidable on the lower surface of the main frame 13.

The locking plate part 243 has a protrusion 243a slightly protruding from a lower surface of the arc-shaped locking plate part 243 to be brought into contact with the upper surface of the main frame 13, and an engaging piece 243b having a generally L shape in side view. The engaging piece 243b is formed in the vicinity of the protrusion 243a and extends from the locking plate part 243 through the opening 137 to the lower surface of the main frame 13. An end of the engaging piece 243b and the protrusion 243a of the locking plate part 243 are slightly shifted in position from each other with the main frame 13 interposed therebetween. The protrusion 243a and the end of the engaging piece 243b are slidable on the upper and the lower surfaces of the main frame 13, respectively.

In the eject lever 24, an eject lever spring 25 illustrated in FIGS. 4, 5, and 8 is fitted around the cylindrical part 240 to urge the eject lever 24 in a counterclockwise direction in FIG. 6. The projecting part 242 of the eject lever 24 is loosely fitted in the opening 226 of the disk holder 22 to be movable in a direction depicted by an arrow E (see FIG. 5).

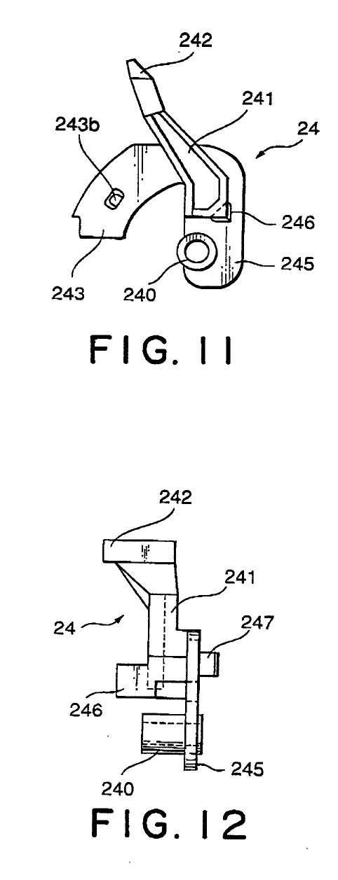

As is obvious from FIG. 12, the holder receiving part 246 standing up on the bar base part 245 is slightly lower in height than the projecting part 242 formed at the free end of the arm part 241 to extend upward. The holder receiving part 246 receives the lower surface of the disk holder 22 which is elevated and changed in position when an eject button 28 (which will later be described) is pushed in the inserting direction A (see FIG. 4). The arm part 241 presses the floppy disk 40 when the floppy disk 40 is ejected. The projecting part 242 of the arm part 241 is engaged with the upper end of the right-hand edge 43b of the shutter 43 of the floppy disk 40 illustrated in FIG. 3 to controllably open and close the shutter 43.

Turning back to FIG. 5, the main frame 13 is provided with a front panel 27 attached to its front end portion. The front panel 27 has an opening 271 for insertion and ejection of the floppy disk and a door 272 for closing the opening 271.

The front panel 27 is provided with the eject button 28 protruding therefrom to be movable backward and forward. The eject button 28 is fitted in a protruding part 214 protruding forward from a front end of the eject plate 21.

The floppy disk 40 driven by the floppy disk drive is same as that described in conjunction with FIG. 3 and has a shell 42 provided with an opening 42a allowing an access to the magnetic recording medium 41 by the magnetic heads 14 of the floppy disk drive. When the floppy disk 40 is not inserted into the floppy disk drive, the opening 42a is covered with the shutter 43 as illustrated in FIG. 3. When the floppy disk is inserted into the floppy disk drive, the projecting part 242 of the eject lever 24 is engaged with the upper end 43b of the right-hand edge of the shutter 43 to slide the shutter 43 in the direction D. In this embodiment, the main frame 13 is provided with the protruding shaft portion 134 so that the eject lever 24 of the floppy disk drive is rotatable. However, this structure is not only adopted to rotate the eject lever 24 but also applicable to any component rotating around a shaft.

The eject lever 24 made of a nonmagnetic material such as resin serves both as a shutter driving mechanism for opening and closing the shutter 43 and as an eject mechanism for ejecting the floppy disk 40 from the floppy disk drive.

By pushing the eject button 28 protruding outward from the front panel 27, the eject plate 21 is slightly moved rearward to rotate the eject lever 24.

The floppy disk 40 loaded in the floppy disk drive is prevented from being undesirably ejected from the floppy disk drive because it is locked by a lock mechanism (not shown). When the lock mechanism is unlocked, the floppy disk 40 is ejected by the eject lever spring 25 as a spring mechanism urging the eject lever 24 so that a part of the floppy disk 40 is ejected outward through the opening 271 of the front panel 27.

The eject plate 21 is provided with the eject spring 23 as a spring mechanism. When the pressing of the eject button 28 is cancelled, the eject plate 21 is returned to its initial position by the eject spring 23. In the above-mentioned manner, the floppy disk 40 can be removed from the floppy disk drive.

As will be understood from the foregoing, it is unnecessary according to this invention to fix the rod pin as a separate component to the main frame 13 by caulking or by the use of a screw so as to stand up on the main frame 13 as described in conjunction with the conventional disk drive. Therefore, the number of components and the number of assembling steps can be reduced.

The main frame 13 is provided with the opening 137 while the locking plate part 243 of the eject lever 24 is provided with the engaging piece 243b. Therefore, by the opening 137 and the engaging piece 243b, the rotation of the eject lever 24 can be controlled in a stable condition.

What is claimed is:

1. A floppy disk drive for driving a floppy disk loaded therein, said floppy disk drive comprising:
a main frame having a principal surface defining a disk-loading area in which said floppy disk is loaded;
a shaft portion protruded from the principal surface of said main frame, said shaft portion being formed integral with said main frame from a single member; and
an eject lever attached to said shaft portion and rotatable around said shaft portion for ejecting said floppy disk from said disk-loading area.

2. The floppy disk drive according to claim 1, wherein said eject lever comprises:
a cylindrical part loosely fitted over said shaft portion;
a bar base part having a flat shape and extending from said cylindrical part in parallel to the principal surface of said main frame; and
an arm part connected to said bar base part and opposite to the principal surface of said main frame for pressing said floppy disk to eject said floppy disk from said disk-loading area.

3. The floppy disk drive according to claim 2, wherein said main frame has an opening in the vicinity of said cylindrical part to communicate said principal surface with an opposite surface opposite to said principal surface, said eject lever further comprising a locking plate part extending from said bar base part through a gap between said arm part and said main frame, said locking plate part having an engaging piece passing through said opening, said engaging piece having an end portion slidable on said opposite surface.

4. The floppy disk drive according to claim 3, wherein said locking plate part has a protrusion protruding to be brought into contact with the principal surface of said main frame, said engaging piece having an end portion offsetting in position from said protrusion with said main frame interposed therebetween, said end portion and said protrusion being slidable on the principal and the opposite surfaces of said main frame, respectively.

5. The floppy disk drive according to claim 2, wherein said floppy disk has a movable shutter, said arm part having a projecting part at a free end thereof, said projecting part being adapted to be engaged with said shutter to controllably open and close said shutter.

6. The floppy disk drive according to claim 5, wherein said eject lever comprises:
a holder receiving part located in the vicinity of said arm part on said bar base part and to have a height lower than that of said projecting part, said holder receiving part being for receiving said disk holder changed in position when said floppy disk is ejected; and
a columnar part extending from said bar base part opposite to said holder receiving part.

7. The floppy disk drive according to claim 1, further comprising:
a motor supported by said main frame for driving said floppy disk;
a magnetic head for accessing to said floppy disk; and
a carriage assembly connected to said main frame and said magnetic head for carrying said magnetic head in parallel to the principal surface of said main frame.

8. The floppy disk drive according to claim 1, further comprising:
a disk holder coupled to said main frame for holding said floppy disk in said disk-loading area;
an eject button adapted to be operated; and
an eject plate movable along the principal surface of said main frame in a loading and ejecting direction of said floppy disk and coupled to said eject button and said eject lever for rotating said eject lever in response to operation of said eject button to make said eject lever eject said floppy disk from said disk-loading area.

9. The floppy disk drive according to claim 1, wherein said main frame further has an opposite surface opposite to said principal surface, said shaft portion is formed by a process selected from burring, coining, and drawing which are applied to said single member from said opposite surface towards said principal surface.
